(19) United States
(12) Patent Application Publication
(10) Pub. No.: US 2025/0070242 A1
(43) Pub. Date: Feb. 27, 2025

(54) COPOLYMER ELECTROLYTE, PREPARATION METHOD THEREOF AND SOLID-STATE LITHIUM SECONDARY BATTERIES

(71) Applicant: Evonik Operations GmbH, Essen (DE)

(72) Inventors: Xiaochuan XU, Shanghai (CN); Jing Feng, Shanghai (CN); Christos Sarigiannidis, Dortmund (DE); Jan Blankenburg, Recklinghausen (DE); Xiayin Yao, Ningbo (CN); Minghui Chen, Shanghai (CN); Xiaowei Tian, Shanghai (CN); Bo Gao, Shanghai (CN); Lin Shen, Ningbo (CN); Zhiyan Wang, Ningbo (CN); Jia Wang, Ningbo (CN)

(73) Assignee: Evonik Operations GmbH, Essen (DE)

(21) Appl. No.: 18/578,112

(22) PCT Filed: Jul. 13, 2022
(86) PCT No.: PCT/CN2022/105316

§ 371 Date: Jan. 10, 2024

(30) Foreign Application Priority Data
Jul. 14, 2021 (WO) PCT/CN2021/106330

(51) Int. Cl. H01M 10/0565; C08F 220/28; C08F 230/08

(52) U.S. Cl. CPC H01M 10/0565; C08F 220/285; C08F 230/08; H01M 2300/0082

(57) ABSTRACT

A monomer composition is made, particularly to prepare a polymer electrolyte precursor composition capable of forming a solid polymer electrolyte. The monomer composition includes A) an alkylene oxide-based monomer and B) a siloxane monomer. A copolymer electrolyte precursor composition is made for preparation of a solid polymer electrolyte. A polymerization method prepares solid copolymer electrolyte. A copolymer, a solid copolymer electrolyte, and a solid-state lithium secondary battery are made. A method to prepare a solid-state lithium secondary battery is developed, and another method improves electrolyte mechanical property, ionic conductivity, and/or cycling performance in a lithium secondary battery by preparing a solid polymer electrolyte the monomer. An electrochemical device and a device are also provided.

### TECHNICAL FIELD

The invention relates to the technical field of lithium secondary battery, in particular to a copolymer electrolyte, a method for preparing the copolymer electrolyte and solid-state lithium secondary batteries.

### BACKGROUND ART

Lithium secondary batteries have been extensively applied in various types of portable electronics and electric vehicles. However, traditional lithium-ion batteries based on liquid electrolyte and graphite anode have potential safety issues and limited energy density due to low theoretical specific capacity of graphite (372 mAh g⁻¹) and the leakage, volatilization and combustion of liquid organic electrolytes. In contrast, solid-state lithium secondary batteries based on lithium metal anode and solid-state electrolyte can solve the above problems effectively.

Among the reported solid-state electrolytes, solid polymer electrolytes (SPEs) have been widely studied due to their good interfacial contact with active materials, excellent geometric diversity and safety properties. Generally, SPEs are composed of a polymer and a lithium salt, in which polymer acts as the Li⁺ transporting host and lithium salt acts as a lithium source. PEO-based SPEs are still considered as promising polymer electrolytes in terms of the merits including stable complexation between ethylene oxide (EO) chains with Li-ion, excellent flexibility and electrochemical compatibility with lithium metal anode.

However, the PEO-based polymer electrolytes usually exist a notorious tradeoff between ionic conductivity and mechanical properties. Generally, reducing the crystallinity of PEO-based electrolytes can enhance the ionic conductivity but sacrifices the mechanical strength, which can't effectively suppress lithium dendrites. While mechanical strength can be elevated by cross-linking reaction but cross-linking reaction leads to low ionic conductivity, which restricts its practical application. Thus, developing the PEO-based electrolyte with high ionic conductivity and good mechanical properties is a huge challenge.

U.S. Pat. No. 6,933,078B2 discloses a crosslinked polymer electrolyte that comprises a poly(ethylene glycol) methyl ether methacrylate (POEM) monomer crosslinked to a low Tg second monomer. The crosslinked polymer electrolytes such as POEM-X-PDMSD-LiN(CF₃SO₂)₂ and POEM-X-PDMSM-PEGDME-LiN(CF₃SO₂)₂ are disclosed. U.S. Pat. No. 6,933,078B2 does not disclose preparation of POEM-X-PDMSM-PEGDME-LiN(CF₃SO₂)₂ but mentioned that “it was found that the PDMSM could be easily grafted onto the POEM monomer but that the PDMSD could be easily crosslinked with the POEM monomer using the free radical synthesis method. (A PDMSM crosslinked polymer can be prepared using alternate synthesis methods.) The POEM-g-PDMSM polymer is a soluble electrolyte with a relatively lower conductivity and poor mechanical properties”. Example 4 discloses preparation 50 of POEM-X-PDMSD-LiN(CF₃SO₂)₂ using POEM (14.8 ml), methacryloxypropyl terminated polydimethylsiloxane (PDMSD) (4.0 ml, ethyl acetate (96 ml), LiN(CF₃SO₂)₂(1.8 g) add AIBN (0.072 g) by solution casting. The patent does not disclose the specific mechanical properties of the crosslinked polymer electrolytes prepared in the examples. The patent does not mention polymer electrolyte's interfacial stability with lithium metal anode.

US20030180624A1 discloses an interpenetrating network solid polymer electrolyte comprising at least one branched siloxane polymer having one or more poly(alkylene oxide) branch as a side chain, at least one crosslinking agent, at least one monofunctional monomeric compound for controlling crosslinking density, at least one metal salt and at least one radical reaction initiator. In Examples 1-2, 0.4-2.0 g branched type siloxane polymer, 0.4 g poly(ethylene glycol-600) dimethacrylate (PEGDMA600) and 1.2-1.6 g poly(ethylene glycol) ethyl ether methacrylate (PEGEEMA) are used to prepare SPEs. During the preparation, porous polycarbonate membrane is used as a supporter for the IPN SPEs. Both of two IPN SPEs show high ionic conductivity over 10⁻⁵ S/cm at room temperature and_as the content of branched type siloxane polymer is increased, so is the ionic conductivity.

In addition, the SPEs are usually prepared by solution casting with large amount of solvents, which not only contaminate the environment but also take much time and cost that is not beneficial for mass production. Therefore, employing solvent-free, economic and efficient method to prepare polymer electrolytes is also urgently needed. Further, there is a need of providing solid-state lithium secondary batteries with excellent cycling and rate performances.

### SUMMARY OF THE INVENTION

The objective of the invention is to provide a solid polymer electrolyte with high ionic conductivity, good mechanical strength and outstanding interfacial stability with lithium metal anode, and a solid-state lithium secondary battery with excellent electrochemical performances such as cycling and rate performances using the solid polymer electrolyte. The solid polymer electrolyte may be prepared by a solvent-free method.

Accordingly, the invention provides a monomer composition, particularly to prepare a polymer electrolyte precursor composition capable to form a solid polymer electrolyte, wherein the monomer composition comprises, consists essentially of, or consists of:
A) an alkylene oxide-based monomer; and
B) a siloxane monomer.

The invention further provides a copolymer electrolyte precursor composition for preparation of a solid polymer electrolyte, wherein the polymer electrolyte precursor composition comprises:
I) the monomer composition according to the invention;
II) a lithium salt; and optionally
III) a free radical initiator for polymerization reaction.

The invention further provides use of the monomer composition according to the invention, or use of the copolymer electrolyte precursor composition of the invention, in preparation of a solid polymer electrolyte in a lithium secondary battery, especially a lithium metal secondary battery, particularly to improve performance such as electrolyte mechanical property, ionic conductivity, and/or cycling performance.

The invention further provides a copolymer of the alkylene oxide-based monomer and the siloxane monomer according to the monomer composition of the invention. The copolymer may be used as a polymer matrix (or host polymer) of a solid polymer electrolyte.

The invention further provides a solid copolymer electrolyte, comprising
a copolymer of the alkylene oxide-based monomer and the siloxane monomer according to the monomer composition of the invention, and
a lithium salt.

The lithium salt is dispersed in the copolymer.

The invention further provides a method, especially a polymerization method for preparing a solid copolymer electrolyte, comprising the following steps:
a) Mixing under protective atmosphere the copolymer electrolyte precursor composition of the invention comprising an alkylene oxide-based monomer, a siloxane monomer, a lithium salt and an initiator until a homogeneous viscous liquid is formed; and
b) Curing the liquid under UV radiation or heating.

When the alkylene oxide-based monomer is methoxypolyethylene glycol methacrylate (MPEG MA) monomer with molecular weight from 950 to 2005, the method for preparing a solid polymer electrolyte of the invention can be solvent-free. The liquid is preferably free of water or organic solvents. Examples of the solvent include but not limited to those conventionally used in the art, such as ethyl acetate, propylene carbonate (PC), ethylene carbonate (EC), diethyl carbonate (DEC), dimethylcarbonate (DMC), dipropyl carbonate, dimethylsulfoxide, dimethoxyethane, N-methyl-2-pyrrolidone (NMP), y-butryolactone (BL), etc.

The term “solvent-free” herein means the method for preparing a solid polymer electrolyte of the invention does not use an amount of solvent that enables preparation of a solid polymer electrolyte by solution casting.

The chemical materials of the method typically comprise solvents in sum in an amount of from 0 to 10 wt. %, for example from 0 to 5 wt. %, preferably 0 to 2 wt. %, more preferably 0 to 1 wt. % even more preferably 0 to 0.5 wt. %, particular preferably 0 to 0.1 wt. % and most preferably does not comprise any solvents, based on the total weight of the chemical materials used in the method. The method preferably does not additionally use any organic solvents.

Importantly, the monomer composition and/or the copolymer electrolyte precursor composition of the invention enables preparation of a solid polymer electrolyte by a solvent-free method.

The invention further provides a solid copolymer electrolyte prepared according to the method of the invention.

The invention further provides a solid-state lithium secondary battery, which comprises a cathode, a solid copolymer electrolyte according to the invention and an anode, preferably a lithium metal anode. The solid-state lithium secondary battery does not comprise a separator that is used in a liquid state lithium secondary battery.

The invention further provides a method to prepare a solid-state lithium secondary battery, comprising,

Assembling a cathode, the solid copolymer electrolyte according to the invention, and an anode, preferably a lithium metal anode, to form a solid-state lithium secondary battery.

In the invention, the term “solid polymer electrolyte” refers to all-solid-state polymer electrolyte and/or quasi-solid-state polymer electrolyte. The solid polymer electrolyte in the invention is preferably all-solid-state polymer electrolyte. When it refers to the solid polymer electrolyte of the invention, the term “copolymer electrolyte” is used interchangeably with “polymer electrolyte”.

In the invention, “lithium secondary battery” includes lithium-ion secondary battery and lithium metal secondary battery.

The present invention further provides an electrochemical device comprising the solid polymer electrolyte according to the present invention.

In some examples, the electrochemical device is a secondary battery, e.g. a lithium-ion battery, especially a lithium metal secondary battery.

The invention further provides a device, comprising the electrochemical device according to the invention. The device includes but not limited to, electric vehicles, electric home appliances, electric tools, portable communication devices such as mobile phones, consumer electronic products, and any other products that are suitable to incorporate the electrochemical device or lithium secondary battery of the invention as an energy source.

The siloxane monomer has double bonds that can copolymerize with alkylene oxide-based monomer to form a copolymer.

The weight ratio of the siloxane monomer to the alkylene oxide-based monomer is typically from 1:0.4 to 1:80, for example, from 1:0.4 to 1:70, from 1:0.4 to 1:60, from 1:0.4 to 1:50, from 1:0.6 to 1:80, from 1:0.6 to 1:70, from 1:0.6 to 1:60, from 1:0.6 to 1:50, from 1:0.8 to 1:80, from 1:0.8 to 1:70, from 1:0.8 to 1:60, from 1:0.8 to 1:55, from 1:0.8 to 1:50, from 1:2.4 to 1:80, from 1-2.4 to 1:70, from 1-2.4 to 1:60, from 1:2.4 to 1:55, from 1:2.4 to 1:50, from 1:3.2 to 1:80, from 1:3.2 to 1:70, from 1:3.2 to 1:60, from 1:3.2 to 1:55, from 1:3.2 to 1:50, especially from 1:0.8 to 1:52, preferably from 1:1.6 to 1:55, from 1:3.2 to 1:55, from 1:6.4 to 1:55, from 10-60, from 12-60, from 15-60, from 20-60, from 25-60, from 10-55, from 12-55, 50 from 15-55, from 20-55, from 25-55, from 1:12.8 to 1:55, from 1:1.6 to 1:50, from 1:3.2 to 1:50, from 1:6.4 to 1:50, from 1:12.8 to 1:50, from 1:3.2 to 1:52, especially from 1:1.6 to 1:52, more preferably from 1:12.8 to 1:55, for example, from 1:16 to 1:55, from 1:16 to 1:52, from 1:20 to 1:52, from 1:25 to 1:52, from 1:16 to 1:50, from 1:16 to 1:42, from 1:16 to 1:32, from 1:20 to 1:30, especially from 1:12.8 to 1:52, e.g. around 1:25.6.

The invention surprising found that only a relatively small amount of the siloxane monomer is required to achieve much better mechanical strength but maintain fairly good ionic conductivity of a solid polymer electrolyte, compared with a solid polymer electrolyte prepared by only alkylene oxide-based monomer. Thus, a good balance of mechanical strength and ionic conductivity is achieved.

The molar ratio of AO/Li⁺ of alkylene oxide-based monomer and lithium salt is preferably (12-20):1, more preferably is (14-18):1, even more preferably is around 16:1. Li⁺ refers to the lithium ion (i.e., charge carriers) provided by the lithium salt. AO represents the alkylene oxide repeating unit of the alkylene oxide-based monomer. For example, EO represents formula (I):

—CH₂CH₂O— (I)
wherein EO is the repeating unit of the EO-based monomer. When EO-based monomer is used, molar ratio of AO/Li⁺ is the molar ratio of EO/Li⁺.

The curing or copolymerization reaction of the alkylene oxide-based monomer and the siloxane monomer may be performed by UV radiation or heat curing.

The copolymerization reaction is preferably initiated by UV radiation. The UV radiation may be performed with 310 nm-380 nm UV under protective atmosphere, e.g. for 30-240 min in ambient temperature. In some embodiments, the UV radiation is performed with 365 nm UV, the time of UV radiation is 120 min.

The copolymerization by UV radiation may be much quicker than heating initiation thus saves much time and cost. Importantly, the prepared electrolytes offer superior electrochemical performance such as ionic conductivity compared with electrolytes prepared by heating initiation, as shown in the examples.

The heating initiation may also be performed at 70° C.-100° C. for 6 hrs-18 hrs under protective atmosphere. In some embodiments, the heating initiation is performed under 80° C., the time of heating-cured is 12 hrs.

In some embodiments, the protective atmosphere is under argon atmosphere, e.g. with O₂, H₂O<0.5 ppm.

In some embodiments, the solvent-free polymerization method for preparing a solid copolymer electrolyte, comprises the steps as follows:
freeze-drying an alkylene oxide-based monomer aqueous solution to remove water;
stirring the alkylene oxide-based monomer, a siloxane monomer, a lithium salt and an initiator intensely until forming a homogeneous viscous liquid under argon atmosphere;
casting the viscous solution and curing the liquid under UV radiation or heating.

### Siloxane Monomer

The siloxane monomer is selected from organomodified siloxanes with ethylenically unsaturated, radically polymerizable groups. The ethylenically unsaturated, radically polymerizable groups are preferably selected from (meth-)acryloxy functions. The siloxane monomer is preferably selected from (meth-)acryloxy functionalized siloxanes with ethylenically unsaturated, radically polymerizable groups. The acryloxy functional group is required for an effective cross-linking.

The number of radically polymerizable groups in the siloxane monomer is typically 3 or more in order to ensure effective crosslinking.

The siloxane monomer is preferably selected from (meth-)acryloxy functionalized siloxanes having 4 to 40 silicon atoms, where 15% to 100% of the silicon atoms have ethylenically unsaturated, radically polymerizable groups.

In some embodiments, the siloxane monomer further comprises ester groups which are not radically polymerizable.

In some embodiments, the siloxane monomer is a compound of formula (II)

M¹ₑM³_{f}D¹_{g}D³ₕ (II)
wherein
M¹=[R¹₃SiO_{1/2}],
M³=[R¹₂R³SiO_{1/2}],
D¹=[R¹₂SiO_{2/2}],
D³=[R¹R³SiO_{2/2}],
e=0 to 2,
f=0 to 2, preferably zero, and e+f=2,
g=0 to 38, preferably 10 to 26,
h=0 to 20, for example 1 to 20, or 2 to 20, or 3 to 20, preferably 4 to 15,
and the ratio of the sum (f+h) to the sum (g+h+2) is from 0.15 up to 1, preferably 0.2 to 0.5,
and the sum (g+h+2) is 4 to 40, preferably 10 to 30,
R¹ denotes identical or different aliphatic hydrocarbons having 1 to 10 carbon atoms or aromatic hydrocarbons having 6 to 12 carbon atoms, preferably methyl and/or
phenyl groups, especially preferably methyl groups,
R³ denotes identical or different hydrocarbons which have 1 to 5 identical or different ester, preferably (meth-)acryloxy functions, the hydrocarbon being linear, cyclic, branched and/or aromatic, preferably linear or branched, and the ester, preferably (meth-)acryloxy functions being selected from ethylenically unsaturated, radically polymerizable ester, preferably (meth-)acryloxy functions and from estergroups which are not radically polymerizable. The ester function of R³ is preferably a (meth-)acryloxy function.

Preferably, in the siloxane monomer, the radically polymerizable groups are present in a numerical fraction of between 80-90%, based on the number of all 50 ester functions of the compounds of the formula (II).

The ethylenically unsaturated, radically polymerizable ester functions of radicals R³ in compounds of the formula (II) are preferably those selected from acrylic and/or methacrylic ester functions, more preferably acrylic ester functions.

The ester groups that are not radically polymerizable of the radicals R³ in compounds of the formula (II) are preferably monocarboxylic acid radicals. The ester groups that are not radically polymerizable are preferably selected from the acid radicals of the acids acetic acid, propionic acid, butyric acid, valeric acid and benzoic acid, more preferably acetic acid. More preferably, the monocarboxylic acid radicals are present in a numerical fraction of 3% to 20%, preferably 5% to 15%, based on the number of all ester functions of the compounds of the formula (II).

The organomodified silicones may be prepared by a process described in U.S. Pat. No. 10,465,032 B2 or U.S. Pat. No. 4,978,726.

A preferred example of the above described siloxane monomer can be TEGOMER® V—Si 7255, commercially available from Evonik Industries AG.

TEGOMER® V—Si 7255 is a comb-like acryloxyfunctional polysiloxane. The chemical name is: Siloxanes and Silicones, 3-[3-(acetyloxy)-2-hydroxypropoxy]propyl Me, di-Me, 3-[2-hydroxy-3-[(1-oxo-2-propen-1-yl)oxy]propoxy]propyl Me; CAS number: 125455-51-8.

### Alkylene Oxide-Based Monomer

The “alkylene oxide-based monomer” in the invention refers to an alkylene oxide based monomer with one, two or more ethylenically unsaturated, radically polymerizable groups. The alkylene oxide is preferably ethylene oxide (EO) or propylene oxide (PO). Thus, the alkylene oxide-based monomer is preferably EO-based monomer or PO-based monomer.

PO-based monomer may be selected from PO based (meth-)acrylates. EO-based monomer may be selected from EO based (meth-)acrylates, especially polyethylene glycol (PEG) (meth-)acrylates, for example, the following monomers:
methoxypolyethylene glycol methacrylate (MPEG MA),
polyethylene glycol dimethacrylate (PEGDMA),
polyethylene glycol methyl ether acrylate (PEGMEA), and
polyethylene glycol diacrylate (PEGDA).

The methoxypolyethylene glycol methacrylate (MPEG MA) monomer may be represented by the following general formula (III),

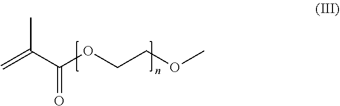

wherein the molecular weight of the MPEG MA monomer is from 200 to 20000, preferably from 750 to 5005, more preferably from 950 to 2005.

The MPEG MA aqueous solution can be VISIOMER® MPEG 750 MA W VISIOMER® MPEG 1005 MA W, VISIOMER® MPEG 2005 MA W, VISIOMER6 MPEG 5005 MA W, all commercially available from Evonik Industries AG. Preferably, the MPEG MA aqueous solution is VISIOMER® MPEG 1005 MA W.

VISIOMER® MPEG 1005 MA W represents methoxypolyethylene glycol 1000-methacrylate 50 wt. % in water. It is a highly polar monomer (50 wt. % in water) with excellent water solubility. The monomer may be represented by the formula (III) wherein the molecular weight is 1005.

The polyethylene glycol dimethacrylate (PEGDMA) monomer may be represented by the following general formula (IV),

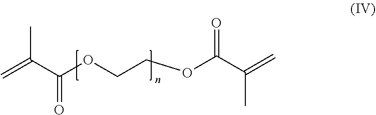

wherein the molecular weight of the PEGDMA monomer is from 200 to 20000, preferably from 550 to 6000, more preferably from 750 to 2000.

The polyethylene glycol methyl ether acrylate (PEGMEA) monomer may be represented by the following general formula (V),

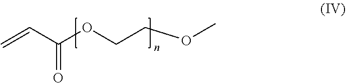

wherein the molecular weight of the PEGMEA monomer is from 200 to 20000, preferably from 300 to 5000, more preferably from 400 to 2000.

The polyethylene glycol diacrylate (PEGDA) monomer may be represented by the following general formula (VI),

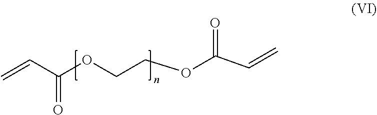

wherein the molecular weight of the PEGDA monomer is from 200 to 20000, preferably from 400 to 5000, more preferably from 600 to 2000.

The alkylene oxide-based monomer may be a solid. In some embodiments, the alkylene oxide-based monomer is obtained by freeze-drying an aqueous solution thereof, e.g. for at least 72 hrs, under vacuum degree<20 Pa and cold trap temperature<−40° C. In one embodiment, the freeze-drying time of alkylene oxide-based monomer aqueous solution is 80 hrs.

### Lithium Salt

The lithium salt is a material that is dissolved in the non-aqueous electrolyte to thereby resulting in dissociation of lithium ions.

The lithium salt may be those used conventional in the art but is thermally stable during in-situ polymerization (e.g. at 80° C.), non-limiting examples may be at least one selected from lithium bis(fluorosulfonyl) imide(LiFSI), lithium bis(trifluoromethanesulfonyl)imide (LiTFSI), lithium difluorooxalate borate (LiODFB), LiAsF₆, LiClO₄, LiN(CF₃SO₂)₂, LiBF₄, LiSbF₆, and LiCl, LiBr, LiI, LiB₁₀Cl₁₀, LiCF₃SO₃, LiCF₃CO₂, LiAlCl₄, CH₃SO₃Li, CF₃SO₃Li, (CF₃SO₂)₂NLi, chloroborane lithium, lower aliphatic carboxylic acid lithium, lithium tetraphenyl borate and imide. The lithium salt is preferably selected from LiTFSI, LiFSI and LiClO₄. These materials may be used alone or in any combination thereof.

### Free Radical Initiator

The free radical initiator of the polymerization reaction is for the thermal- or photo-polymerization reaction of the reactive monomers, and may be those conventional in the art.

Examples of free radical initiator or the polymerization initiator may include azo compounds such as 2,2-azobis(2-cyanobutane), 2,2-azobis(methylbutyronitrile), 2,2′-azoisobutyronitrile (AIBN), azobisdimethyl-valeronitrile (AMVN) and the like, peroxy compounds such as benzoyl peroxide, acetyl peroxide, dilauryl peroxide, di-tert-butyl peroxide, cumyl peroxide, hydrogen peroxide and the like, and hydroperoxides. Preferably, AIBN, 2,2′-azobis(2,4-dimethyl valeronitrile) (V65), Di-(4-tert-butylcyclohexyl)-peroxydicarbonate (DBC), or the like may also be employed.

Preferably the free radical thermal initiator may be selected from azobisisobutyronitrile (AIBN), azobisisoheptanenitrile (ABVN), benzoyl peroxide (BPO), lauroyl peroxide (LPO) and so on. More preferably, the free radical initiator is benzoyl peroxide (BPO) or azobisisobutyronitrile (AIBN).

The free radical photoinitiators produce free radicals when exposed to UV light, then setup the polymerization. Examples of photoinitiators may include benzoyl compounds such as 2,2-dimethoxy-1,2-diphenyl-ethan-1-one (DMPA), Benzil Dimethyl Ketal, diphenyl(2,4,6-trimethylbenzoyl)phosphine oxide (TPO), 2-hydroxy-2-methyl propiophenone (HMPP), 1-hydroxycyclohexyl phenyl ketone (HCPK), and the like may also be employed.

Preferably the free radical photoinitiator may be selected from 2,2-dimethoxy-1,2-diphenyl-ethan-1-one (DMPA), Benzil Dimethyl Ketal, diphenyl(2,4,6-trimethylbenzoyl)phosphine oxide (TPO) and so on. More preferably, the free radical photoinitiator is 2,2-dimethoxy-1,2-diphenyl-ethan-1-one (DMPA).

The amount of the free radical initiator is conventional. Preferably the amount of the free radical initiator is 0.1-3 wt. %, more preferably around 0.5 wt. % based on the total weight of the monomers of the copolymer.

In some embodiments, the amount of the photoinitiator or thermal initiator may be 0.2 wt. %-2 wt. %, preferably around 0.5 wt. % based on the total weight of the 50 alkylene oxide-based monomer and siloxane monomer. The photoinitiator or thermal initiator generates free radicals to initiate polymerization under UV irradiation or heating.

In some embodiments, the polymerization initiator is decomposed at a certain temperature of 40 to 80° C. to form radicals, and may react with monomers via the free radical polymerization to form a polymer electrolyte. Generally, the free radical polymerization is carried out by sequential reactions consisting of the initiation involving formation of transient molecules having high reactivity or active sites, the propagation involving re-formation of active sites at the ends of chains by addition of monomers to active chain ends, the chain transfer involving transfer of the active sites to other molecules, and the termination involving destruction of active chain centers.

Preferably, the solid-state lithium secondary batteries can be coin batteries or pouch batteries.

The electrochemical device encompasses all kinds of devices that undergo electrochemical reactions. Examples of the electrochemical device include all kinds of primary batteries, secondary batteries, fuel cells, solar cells, capacitors and the like, preferably secondary batteries.

Generally, the secondary battery is fabricated by inclusion of the electrolyte in an electrode assembly composed of a cathode and an anode, which are faced opposite to each other with (or without for SPE) a separator therebetween.

The cathode is, for example, fabricated by applying a mixture of a cathode active material, a conductive material and a binder to a cathode current collector, followed by drying and pressing. If necessary, a filler may be further added to the above mixture.

The cathode current collector is generally fabricated to have a thickness of 3 to 500 μm. There is no particular limit to materials for the cathode current collector, so long as they have high conductivity without causing chemical changes in the fabricated battery. Examples of the materials for the cathode current collector may include stainless steel, aluminum, nickel, titanium, sintered carbon, and aluminum or stainless steel which was surface-treated with carbon, nickel, titanium or silver. The current collector may be fabricated to have fine irregularities on the surface thereof so as to enhance adhesion to the cathode active material. In addition, the current collector may take various forms including films, sheets, foils, nets, porous structures, foams and non-woven fabrics.

Examples of the cathode active materials that can be used in the present invention may include, but are not limited to, layered compounds such as lithium cobalt oxide (LiCoO₂) and lithium nickel oxide (LiNiO₂), or compounds substituted with one or more transition metals such as LiNiₓCo_{y}Mn_{1-x-y}(NCM); lithium manganese oxides such as compounds of Formula Li₁₊ₓMn₂₋ₓO₄ (0≤x≤0.33), LiMnO₃, LiMn₂O₃ and LiMnO₂; lithium copper oxide (Li₂CuO₂); vanadium oxides such as LiV₃O₈, V₂O₅ and Cu₂V₂O₇; Ni-site type lithium nickel oxides of Formula LiNi₁₋ₓMnO₂ (M═Co, Mn, Al, Cu, Fe, Mg, B or Ga, and 0.01≤x≤0.3); lithium manganese composite oxides of Formula LiMn₂₋ₓMₓO₂ (M═Co, Ni, Fe, Cr, Zn or Ta, and 0.01≤x≤0.1), or Formula Li₂Mn₃MO₈ (M=Fe, Co, Ni, Cu or Zn); LiMn₂O₄ wherein a portion of Li is substituted with alkaline earth metal ions; disulfide compounds; and Fe₂(MoO₄)₃, LiFe₃O₄, etc. In some embodiments, the cathode active material is selected from LiFePO₄, LiCoO₂, LiNi_{0.8}Mn_{0.1}Co_{0.1}O₂, LiNi_{0.6}Mn_{0.2}Co_{0.2}O₂, LiNi_{0.85}Co_{0.05}Al_{0.1}O₂, all are commercially available common cathode.

In some embodiments, the cathode slurry is obtained by blending cathode active material, super-p, binder and lithium perchlorate (LiClO₄) in a solvent, and then the slurry is loaded directly onto aluminum foil by blade casting and dried under vacuum for removing solvent. In some embodiments, the weight ratio of cathode active material, super-p, binder and LiClO₄ is (67%-89%):(5%-20%):(5%-10%):(1%-3%).

Preferably, the weight ratio of cathode active material, super-p, binder and LiClO₄ is 78.94-%:9.87%:9.87%:1.32%.

Preferably, the solvent used in preparing the cathode slurry is acetonitrile or N-Methyl pyrrolidone. Usually, acetonitrile is used when the binder is PEO. N-Methyl pyrrolidone is used when the binder is PVDF.

Preferably, the temperature of drying cathode slurry is 60° C.-120° C. The time of drying cathode slurry can preferably be 10-24 hrs, more preferably is 12 hrs.

The conductive material is typically added in an amount of 1 to 50% by weight, based on the total weight of the mixture including the cathode active material. There is no particular limit to the conductive material, so long as it has suitable conductivity without causing chemical changes in the fabricated battery. Examples of conductive materials may include conductive materials including graphite such as natural or artificial graphite; carbon blacks such as carbon black, acetylene black, Ketjen black, channel black, furnace black, lamp black and thermal black; conductive fibers such as carbon fibers and metallic fibers; metallic powders such as carbon fluoride powder, aluminum powder and nickel powder; conductive whiskers such as zinc oxide and potassium titanate; conductive metal oxides such as titanium oxide; and polyphenylene derivatives.

The binder is a component assisting in binding between the active material and conductive material, and in binding with the current collector. The binder is typically added in an amount of 1 to 50% by weight, based on the total weight of the mixture including the cathode active material. Examples of the binder may include polyvinylidene fluoride, poly(ethylene oxide)(PEO), polyvinyl alcohols, carboxymethylcellulose (CMC), starch, hydroxypropylcellulose, regenerated cellulose, polyvinyl pyrollidone, tetrafluoroethylene, polyethylene, polypropylene, ethylene-propylene-diene terpolymer (EPDM), sulfonated EPDM, styrene butadiene rubber, fluoro rubber and various copolymers.

In some embodiments, the polymer binder is poly(ethylene oxide)(PEO) or poly(vinylidene fluoride)(PVDF).

The filler is an optional ingredient used to inhibit cathode expansion. There is no particular limit to the filler, so long as it does not cause chemical changes in the fabricated battery and is a fibrous material. As examples of the filler, there may be used olefin polymers such as polyethylene and polypropylene; and fibrous materials such as glass fiber and carbon fiber. The anode is fabricated by applying an anode active material to the anode current collector, followed by drying. If necessary, other components as described above may be further included.

The anode current collector is generally fabricated to have a thickness of 3 to 500 μm. There is no particular limit to materials for the anode current collector, so long as they have suitable conductivity without causing chemical changes in the fabricated battery. Examples of materials for the anode current collector may include copper, stainless steel, aluminum, nickel, titanium, sintered carbon, copper or stainless steel having a surface treated with carbon, nickel, titanium or silver, and aluminum-cadmium alloys. Similar to the cathode current collector, the anode current collector may also be processed to form fine irregularities on the surfaces thereof so as to enhance adhesive strength to the anode active material. In addition, the anode current collector may be used in various forms including films, sheets, foils, nets, porous structures, foams and non-woven fabrics.

Examples of the anode active materials utilizable in the present invention include carbon such as non-graphitizing carbon and graphite-based carbon; metal composite oxides such as LiₓFe₂O₃ (0≤x≤1), LiₓWO₂(0≤x≤1) and SnₓMe₁₋ₓMe′_{y}O_{z} (Me: Mn, Fe, Pb or Ge; Me′: Al, B, P, Si, Group I, Group II and Group Ill elements of the Periodic Table of the Elements, or halogens; 0≤x≤1; 1≤y≤3; and 1≤z≤8); lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; and Li—Co—Ni based materials. In some examples of this invention, lithium metal is employed as anode.

The secondary battery according to the present invention may be, for example, a lithium metal secondary battery, a lithium-ion secondary battery, a lithium polymer secondary battery, lithium-ion polymer secondary battery or the like. The secondary battery may be fabricated in various forms. For example, the electrode assembly may be constructed in a jelly-roll structure, a stacked structure, a stacked/folded structure or the like. The battery may take a configuration in which the electrode assembly is installed inside a battery case of a cylindrical can, a prismatic can or a laminate sheet including a metal layer and a resin layer. Such a configuration of the battery is widely known in the art.

Therefore, the invention provides a novel monomer composition and a polymer electrolyte precursor composition, which is capable to form a solid polymer electrolyte with good performance such as high ionic conductivity, good mechanical strength and outstanding interfacial stability with lithium metal anode, and a solid-state lithium secondary battery with excellent electrochemical performances such as cycling and rate performances using the solid polymer electrolyte.

The copolymer electrolyte provided in this invention has high ionic conductivity, good mechanical strength, excellent dendrite suppression capability and thermal stability.

This invention also provides a solvent-free polymerization method for preparing the copolymer electrolyte. This method avoids solvent contamination, has high production efficiency and can be performed at ambient temperature, which is beneficial to industrial mass production.

The solid-state lithium secondary batteries provided in this invention deliver excellent cycling and rate performances.

Other advantages of the present invention would be apparent for a person skilled in the art upon reading the specification.

### BRIEF DESCRIPTION OF DRAWINGS

FIG. 1 shows the stress-strain curve of the obtained electrolyte of Example 2. FIG. 2 shows the stress-strain curve of the obtained electrolyte of Example 5.

FIG. 3 shows the Micro-Fourier transform infrared spectroscopy (Micro-FTIR) spectra of the reactive monomer and the obtained copolymer electrolyte of Example 6.

FIG. 4 shows scanning electron microscopy (SEM) image and corresponding elemental distribution spectroscopy (EDS) mappings of the obtained electrolyte of Example 6.

FIG. 5 shows the thermogravimetric analysis (TGA) curves of the obtained electrolyte of Example 6.

FIG. 6 shows differential scanning calorimetry (DSC) curves of the obtained electrolyte of Example 6.

FIG. 7 shows the stress-strain curve of the obtained electrolyte of Example 6.

FIG. 8 shows the galvanostatic cycling for the Li/electrolyte/Li symmetric battery of Example 6 at current density of 0.1 mA cm² under 60° C.

FIG. 9 shows the stress-strain curve of the obtained electrolyte of Example 8.

FIG. 10 shows rate capability of the all-solid-state lithium secondary battery employing electrolyte of Example 6 at different current rate under 60° C.

FIG. 11 shows charge/discharge profiles of the all-solid-state lithium secondary battery employing electrolyte of Example 6 at different rate under 60° C.

FIG. 12 shows cycling performance of the all-solid-state lithium secondary battery employing electrolyte of Example 6 at 0.1 C under 60° C.

FIG. 13 shows cycling performance of the all-solid-state lithium secondary battery employing electrolyte of Example 6 at 1 C under 60° C.

FIG. 14 shows the stress-strain curve of the obtained electrolyte of Comparative Example 1.

FIG. 15 shows the galvanostatic cycling for the Li/electrolyte/Li symmetric battery of Comparative Example 1 at current density of 0.1 mA cm⁻² under 60° C.

FIG. 16 shows the stress-strain curve of the obtained electrolyte of Comparative Example 2.

FIG. 17 shows rate capability of the all-solid-state lithium secondary battery employing electrolyte of Comparative Example 1 at different current rate under 60° C.

FIG. 18 shows cycling performance of the all-solid-state lithium secondary battery employing electrolyte of Comparative Example 1 at 0.1 C under 60° C.

### DETAILED DESCRIPTION OF THE INVENTION

The invention is now described in detail by the following examples. The scope of the invention should not be limited to the embodiments of the examples.

### Analytical Procedures

The ionic conductivity of the obtained electrolyte was measured on the Solartron 1470E multi-channel potentiostat electrochemical workstation (Solartron Analytical, UK) by electrochemical impedance spectroscopy (EIS) method with the amplitude of 10 mV at a frequency range from 10 MHz to 10 Hz, where the electrolyte was sandwiched between two stainless steel (SS) electrodes to assemble symmetric coin cell. The ionic conductivity was calculated by the equation σ=L/(S·R), where L is thickness of the electrolyte, R represents the resistance value of the bulk electrolyte and S stands for the effective contact area between SS electrodes and electrolyte.

The chemical structure of the obtained electrolyte was characterized by Micro-Fourier transform infrared spectroscopy (Micro-FTIR, Cary660+620, Agilent, US).

The morphology and elemental distribution spectroscopy (EDS) mappings of the obtained electrolyte were investigated by field emission scanning electron microscopy (FE-SEM, S4800, Hitachi, Japan).

The thermal behavior of the obtained electrolyte was investigated by differential scanning calorimetry (DSC, DSC214, NETZSCH, Germany) with a heating rate of 10° C. min⁻¹ from −60° C. to 80° C. and thermogravimetric analysis (TGA, Diamond TG/DTA, PerkinElmer, US) with a heating rate of 10° C. min⁻¹ from 30° C. to 600° C. under nitrogen atmosphere.

The mechanical strength of the obtained electrolyte was tested by stress-strain measurements on Electronic Universal Testing Machine (CMT-1104, Zhuhai SUST Electrical Equipment Co. Ltd., China).

The charge-discharge cycles were performed on a Land charge/discharge instrument (LAND CT2001A, Wuhan Rambo Testing Equipment Co., Ltd., China).

In the examples, purified VISIOMER® MPEG 1005 MA W was obtained as follows, VISIOMER® MPEG 1005 MA W was placed in a refrigerator for freezing, then the frozen sample was freeze-dried for 80 hrs under vacuum degree<20 Pa and cold trap temperature<−40° C. by means of a vacuum freeze dryer SCIENTZ-10N (Ningbo Scientz Biotechnology Co., Ltd., China) to remove water.

### Example 1

Under argon atmosphere, the purified solid VISIOMER® MPEG 1005 MA W monomer(1.4680 g), TEGOMER® V—Si 7255(1.8259 g), LiTFSI0.5320 g), 1 wt. % DMPA(0.0238 g, based on the weight amount of TEGOMER® V—Si 7255 and VISIOMER® MPEG 1005 MA W monomer) were intensely stirred until forming a homogeneous viscous liquid, the molar ratio of EO/Li⁺ was set to be 18:1, the weight ratio of TEGOMER® V—Si 7255 to purified VISIOMER® MPEG 1005 MA W was set to be 1: 0.804. The precursor solution was then casted onto a Teflon plate and exposed to a UV beam with 365 nm for 100 min at ambient temperature. Finally, a solvent-free self-supported copolymer electrolyte was obtained. The copolymer electrolyte of Example 1 delivered ionic conductivities of 1.22×10⁻⁶ S cm⁻¹ at 30° C. and 7.58×10⁻⁵ cm⁻¹ at 60° C.

### Example 2

Under argon atmosphere, the purified VISIOMER® MPEG 1005 MA W monomer(1.4680 g), TEGOMER® V—Si 7255(0.9130 g), LiTFSI(0.5320 g), 1 wt. % DMPA(0.0238 g, based on the weight amount of TEGOMER V—Si 7255 and VISIOMER® MPEG 1005 MA W monomer) were intensely stirred until forming a homogeneous viscous liquid, the molar ratio of EO/Li⁺ was set to be 18:1, the weight ratio of TEGOMER® V—Si 7255 to purified VISIOMER® MPEG 1005 MA W was set to be 1:1.608. The precursor solution was then casted onto a Teflon plate and exposed to a UV beam with 365 nm for 100 min at ambient temperature. Finally, a solvent-free self-supported copolymer electrolyte was obtained. The copolymer electrolyte of Example 2 delivered ionic conductivities of 2.02×10⁻⁵ S cm⁻¹ at 30° C. and 9.82×10⁻⁵ S cm⁻¹ at 60° C.

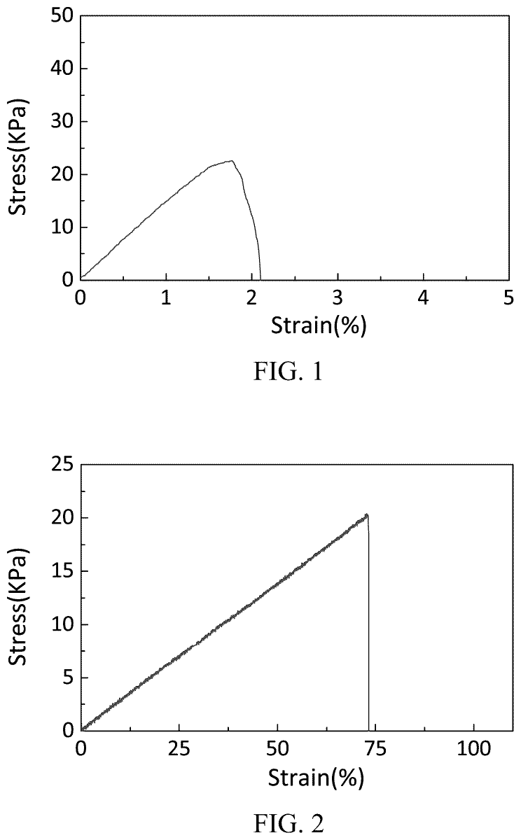

The mechanical strength of the obtained electrolyte of Example 2 was tested by stress-strain measurements. As shown in FIG. 1, the obtained electrolyte of Example 2 was brittle and the elongation at break was only 1.75%. In addition, the tensile strength and Young's modulus of the obtained electrolyte of Example 2 were 22.57 KPa and 1156.64 KPa, respectively. The obtained electrolyte of Example 2 had a much higher mechanical strength than the electrolytes of Comparative Example 1 and Comparative Example 2 below.

### Example 3

Under argon atmosphere, the purified VISIOMER® MPEG 1005 MA W monomer(1.4680 g), TEGOMER® V—Si 7255(0.4565 g), LiTFSI(0.5320 g), 0.5 wt. % DMPA(0.0096 g, based on the weight amount of TEGOMER® V—Si 7255 and VISIOMER® MPEG 1005 MA W monomer) were intensely stirred until forming a homogeneous viscous liquid, the molar ratio of EO/Li⁺ was set to be 18:1, the weight ratio of TEGOMER® V—Si 7255 to purified VISIOMER® MPEG 1005 MA W was set to be 1:3.216. The precursor solution was then casted onto a Teflon plate and exposed to a UV beam with 365 nm for 120 min at ambient temperature. Finally, a solvent-free self-supported copolymer electrolyte was obtained. The copolymer electrolyte of Example 3 delivered ionic conductivities of 2.18×10⁻⁴ S cm⁻¹ at 60° C.

### Example 4

Under argon atmosphere, the purified VISIOMER® MPEG 1005 MA W monomer(1.4680 g), TEGOMER® V—Si 7255(0.1141 g), LiTFSI(0.5320 g), 0.5 wt. % DMPA(0.0079 g, based on the weight amount of TEGOMER® V—Si 7255 and VISIOMER® MPEG 1005 MA W monomer) were intensely stirred until forming a homogeneous viscous liquid, the molar ratio of EO/Li⁺ was set to be 18:1, the weight ratio of TEGOMER® V—Si 7255 to purified VISIOMER® MPEG 1005 MA W was set to be 1:12.864. The precursor solution was then casted onto a Teflon plate and exposed to a UV beam with 365 nm for 120 min at ambient temperature. Finally, a solvent-free self-supported copolymer electrolyte was obtained. The copolymer electrolyte of Example 3 delivered ionic conductivities of 5.85×10×⁻⁵ S cm⁻¹ at 30° C. and 2.38×10⁻⁴ S cm⁻¹ at 60° C.

### Example 5

Under argon atmosphere, the purified VISIOMER® MPEG 1005 MA W monomer(1.4680 g), TEGOMER® V—Si 7255(0.0571 g), LiTFSI(0.5320 g), 0.5 wt % DMPA(0.0076 g, based on the weight amount of TEGOMER® V—Si 7255 and VISIOMER® MPEG 1005 MA W monomer) were intensely stirred until forming a homogeneous viscous liquid, the molar ratio of EO/Li⁺ was set to be 18:1, the weight ratio of TEGOMER® V—Si 7255 to purified VISIOMER® MPEG 1005 MA W was set to be 1:25.728. The precursor solution was then casted onto a Teflon plate and exposed to the UV beam with 365 nm for 120 min at ambient temperature. Finally, a solvent-free self-supported copolymer electrolyte was obtained. The copolymer electrolyte of Example 5 delivered ionic conductivities of 7.10×10⁻⁵ S cm⁻¹ at 30° C. and 2.92×10⁻⁴ S cm⁻¹ at 60° C.

The mechanical strength of the obtained electrolyte of Example 5 was tested by stress-strain measurements. As shown in FIG. 2, the tensile strength and Young's modulus of the obtained electrolyte of Example 5 were 20.05 KPa and 27.42 KPa, respectively. The obtained electrolyte of Example 5 had a much higher mechanical strength than the electrolytes of Comparative Example 1 and Comparative Example 2 below.

### Example 6

Under argon atmosphere, the purified VISIOMER® MPEG 1005 MA W monomer(1.4680 g), TEGOMER® V—Si 7255(0.0571 g), LiTFSI(0.5985 g), 0.5 wt % DMPA(0.0076 g, based on the weight amount of TEGOMER® V—Si 7255 and 50 VISIOMER® MPEG 1005 MA W monomer) were intensely stirred until forming a homogeneous viscous liquid, the weight ratio of EO/Li⁺ was set to be 16:1, the molar ratio of TEGOMER V—Si 7255 to purified VISIOMER® MPEG 1005 MA W was set to be 1:25.728. The precursor solution was then casted onto a Teflon plate and exposed to the UV beam with 365 nm for 120 min at ambient temperature. Finally, a solvent-free self-supported copolymer electrolyte was obtained. The copolymer electrolyte of Example 6 delivered ionic conductivity of 1×10⁻⁴ S cm⁻¹ at 30° C. and 3.86×10⁻⁴ S cm⁻¹ at 60° C.

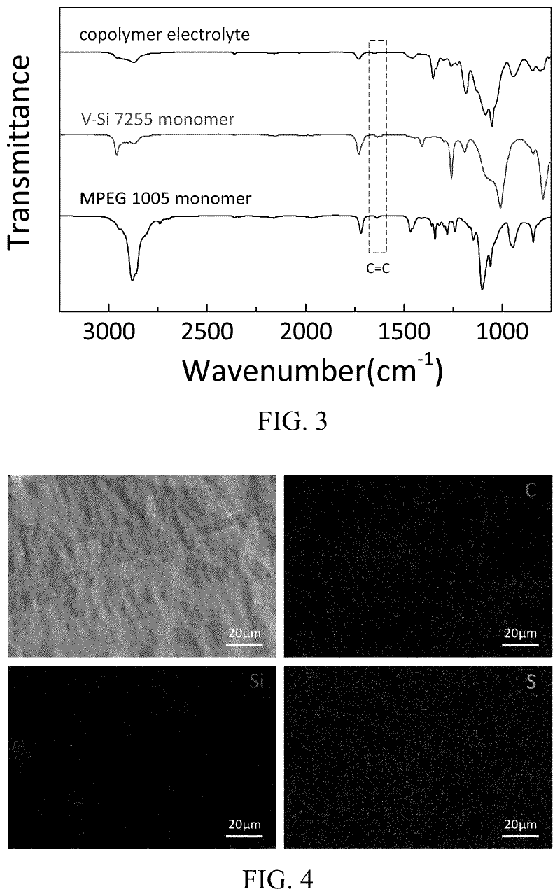

The structure of the obtained electrolyte of Example 6 was characterized by Micro-FTIR and FE-SEM. As shown in FIG. 3 and FIG. 4, the reactive group located at 1633 cm⁻¹ for C═C double bond in the purified VISIOMER® MPEG 1005 MA W monomer and TEGOMER® V—Si 7255 disappeared in the obtained electrolyte of Example 6, and there were uniform distribution of C, Si and S in the obtained electrolyte of Example 6, proving the copolymer electrolyte of Example 6 had been successfully prepared.

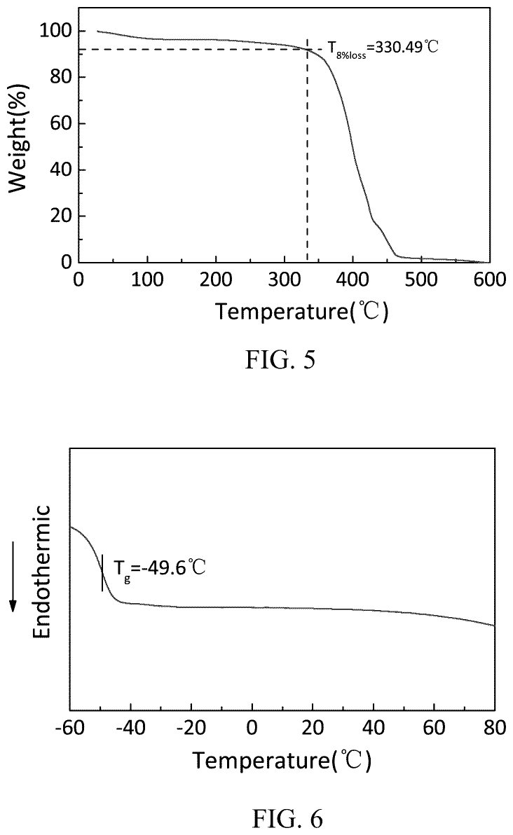

The thermal behavior of the obtained electrolyte of Example 6 was investigated by means of thermogravimetric analysis (TGA) and differential scanning calorimetry (DSC). FIG. 5 presents the TGA result. The electrolyte can remain stable until 330.49° C. with 8% weight loss, indicating its excellent thermal stability in case of thermal abuse. As shown in FIG. 6, the glass transition temperature (T_{g}) was −49.6° C. and no endothermic peak could be observed with the temperature increase. The result indicates that the electrolyte was totally amorphous, which was beneficial for ionic conduction.

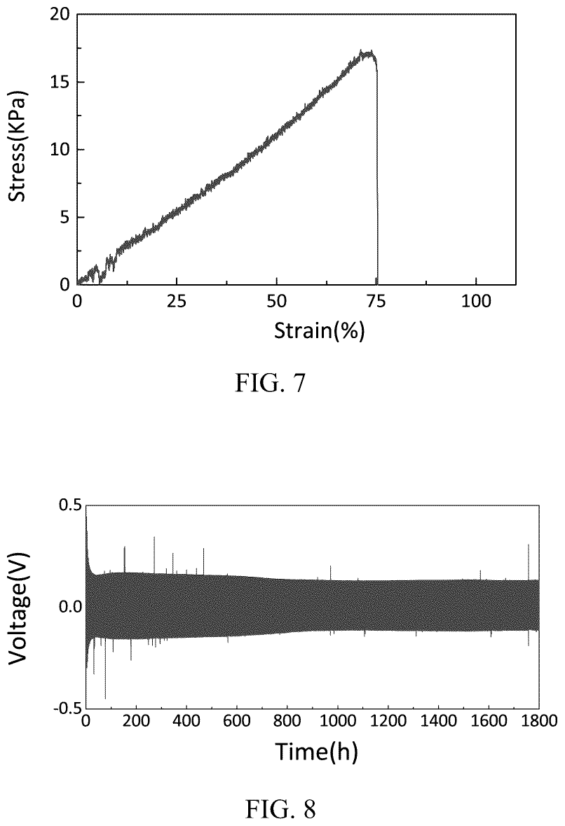

The mechanical strength of the obtained electrolyte of Example 6 was tested by stress-strain measurements. As shown in FIG. 7, the tensile strength and Young's modulus of the obtained electrolyte of Example 6 were 17.28 KPa and 24.43 KPa, respectively. The inventive electrolyte had a much higher mechanical strength than the electrolytes of Comparative Example 1 and Comparative Example 2 below.

The interfacial stability between the obtained electrolyte of Example 6 and lithium metal was tested, the Li/electrolyte/Li symmetric battery can stably cycle for over 1800 hrs at current density of 0.1 mA cm⁻² at 60° C. (FIG. 8). The result indicates the electrolyte has excellent stability with lithium metal and can efficiently suppress lithium dendrite due to its good mechanical property.

### Example 7

Under argon atmosphere, the purified VISIOMER® MPEG 1005 MA W monomer(1.4680 g), TEGOMER® V—Si 7255(0.0571 g), LiTFSI(0.6840 g), 0.5 wt % DMPA(0.0076 g, based on the weight amount of TEGOMER® V—Si 7255 and VISIOMER® MPEG 1005 MA W monomer) were intensely stirred until forming a homogeneous viscous liquid, the molar ratio of EO/Li⁺ was set to be 14:1, the weight ratio of TEGOMER® V—Si 7255 to purified VISIOMER® MPEG 1005 MA W was set to be 1:25.728. The precursor solution was then casted onto a Teflon plate and exposed to the UV beam with 365 nm for 120 min at ambient temperature. Finally, a solvent-free self-supported copolymer electrolyte was obtained. The copolymer electrolyte of Example 7 delivered ionic conductivity of 7.15×10⁻⁵ S cm⁻¹ at 30° C. and 3.12×10×⁻⁴ S cm⁻¹ at 60° C.

### Example 8

Under argon atmosphere, the purified VISIOMER® MPEG 1005 MA W monomer(1.4680 g), TEGOMER® V—Si 7255(0.0285 g), LiTFSI(0.5985 g), 0.5 wt % DMPA(0.0075 g, based on the weight amount of TEGOMER® V—Si 7255 and VISIOMER® MPEG 1005 MA W monomer) were intensely stirred until forming a homogeneous viscous liquid, the molar ratio of EO/Li⁺ was set to be 16:1, the weight ratio of TEGOMER® V—Si 7255 to purified VISIOMER® MPEG 1005 MA W was set to be 1:51.456. The precursor solution was then casted onto a Teflon plate and exposed to the UV beam with 365 nm for 120 min at ambient temperature. Finally, a solvent-free self-supported copolymer electrolyte was obtained. The copolymer electrolyte of Example 8 delivered ionic conductivity of 1.15×10⁻⁴ S cm⁻¹ at 30° C. and 4.8810×⁻⁴ S cm⁻¹ at 60° C.

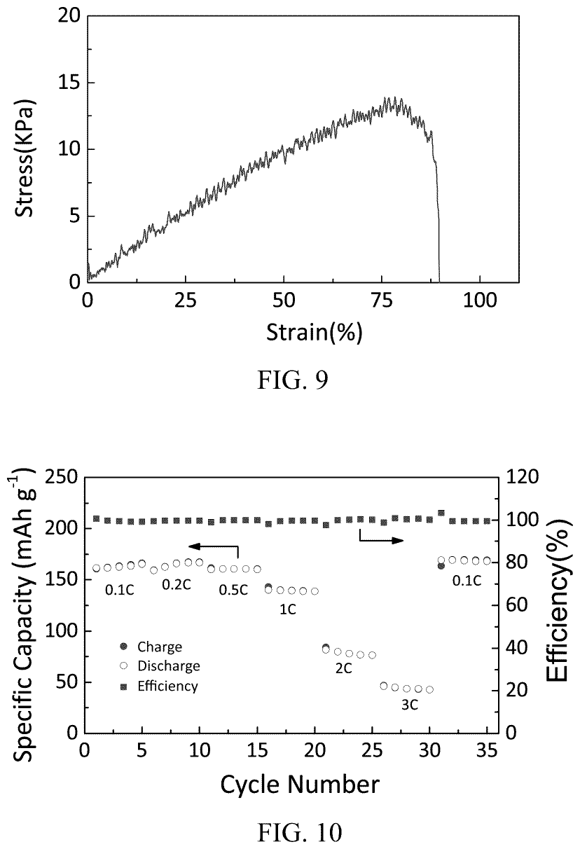

The mechanical strength of the obtained electrolyte of Example 8 was tested by stress-strain measurements. As shown in FIG. 9, the tensile strength and Young's modulus of the obtained electrolyte of Example 8 are 13.22 KPa and 14.85 KPa, respectively. The obtained electrolyte of Example 8 had higher mechanical strength than the electrolytes of Comparative Example 1 and Comparative Example 2 below.

### Example 9

Under argon atmosphere, the purified VISIOMER® MPEG 1005 MA W monomer(1.4680 g), TEGOMER® V—Si 7255(0.0571 g), LiTFSI(0.5985 g), 0.5 wt % BPO(0.0076 g, based on the weight amount of TEGOMER V—Si 7255 and VISIOMER® MPEG 1005 MA W monomer) were intensely stirred until forming a homogeneous viscous liquid, the molar ratio of EO/Li⁺ was set to be 16:1, the weight ratio of TEGOMER® V—Si 7255 to purified VISIOMER® MPEG 1005 MA W was set to be 1:25.728. The precursor solution was then casted onto a Teflon plate and put in an oven at 80° C. for 12 hrs. The copolymer electrolyte of Example 9 delivered ionic conductivity of 5.56×10⁻⁵ S cm⁻¹ at 30° C. and 3.11×10×⁻⁴ S cm⁻¹ at 60° C.

### Example 10

All-solid-state lithium secondary batteries were further assembled under argon atmosphere (O₂, H₂O<0.5 ppm), which consisted of a cathode, the obtained electrolyte of Example 6 and a lithium metal anode. The cathode slurry was obtained by blending LiFePO₄(0.4 g)/carbon black Super-P(0.05 g)/PEO(0.05 g)/LiClO₄(0.0067 g) at the weight ratio of 78.94%:9.87%:9.87%:1.32% in acetonitrile, and then the slurry was loaded directly onto aluminum foil by blade casting and dried under vacuum for 12 h at 100° C. to remove solvent.

FIG. 10 shows the rate performances of the all-solid-state lithium secondary battery at 60° C. As shown in FIG. 10, the maximum discharge specific capacities of the battery reached to 169.2 mAh g⁻¹, 166.8 mAh g⁻¹, 160.5 mAh g⁻¹, 140.3 mAh g⁻¹, 81.9 mAh g⁻¹, 46.3 mAh g⁻¹ at 0.1 C, 0.2 C, 0.5 C, 1 C, 2 C and 3 C, respectively, which indicates excellent rate performances of the all-solid-state lithium cell.

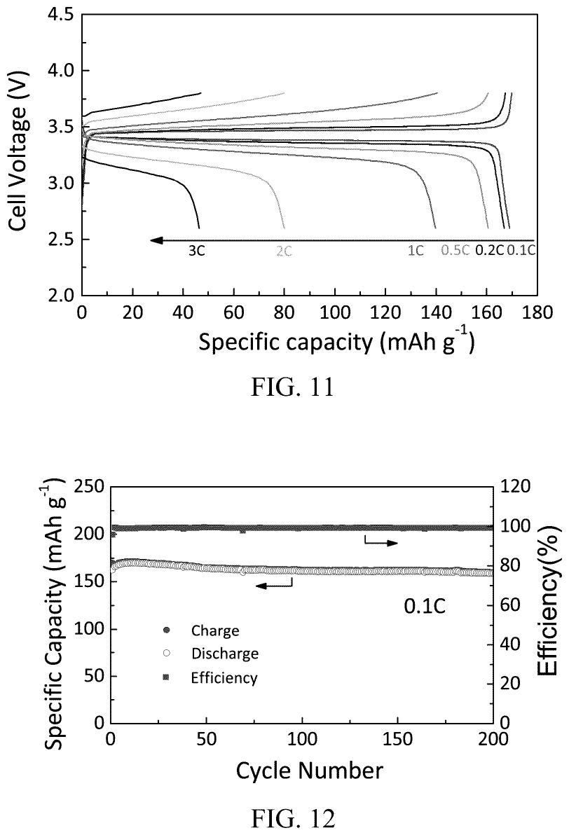

In addition, FIG. 11 presents the charging/discharging profiles of the all-solid-state lithium secondary battery at different rate current, the voltage polarization plateaus correspond to the reaction of Fe²⁺/Fe³⁺ at LiFePO₄ cathode. The polarization voltage grows as the current rate increases, which is mainly ascribed to electrochemical polarization and Li⁺ concentration polarization in cathode.

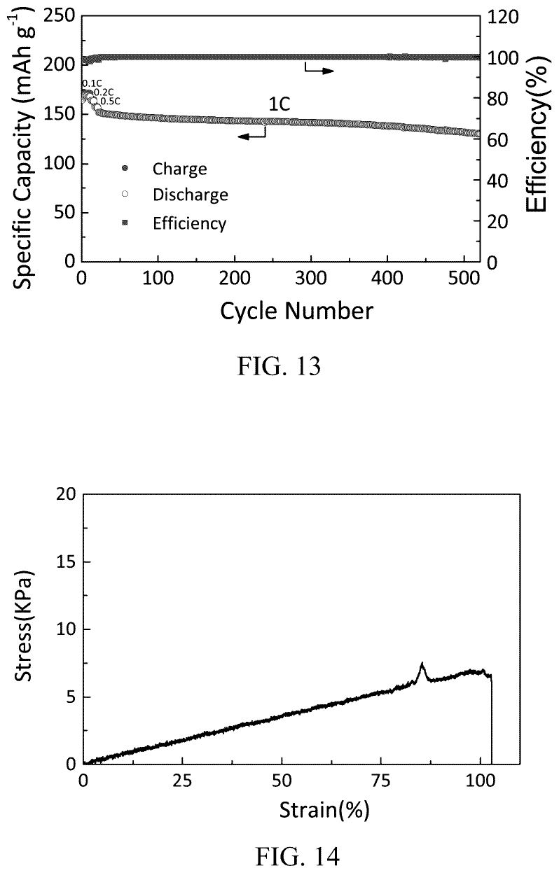

The cycling performance of the all-solid-state lithium secondary battery was evaluated at 0.1 C under 60° C. As shown in FIG. 12, the all-solid-state lithium secondary battery can still deliver a discharge capacity of 158.7 mAh g⁻¹ with the capacity retention rate of 97.6% after 200 cycles, which demonstrates excellent cycling performances of the all-solid-state lithium cell. Furthermore, the cycling performance of the all-solid-state lithium secondary battery was evaluated at higher current rate under 60° C. As illustrated in FIG. 13, after cycling at 0.1 C for 11 cycles, at 0.2 C for 5 cycles and at 0.5 C for 5 cycles, the current rate was increased to 1 C, and the all-solid-state lithium secondary battery can still deliver a discharge capacity of 130.3 mAh g⁻¹ with the capacity retention rate of 85.6% after 500 cycles.

### Comparative Example 1

Under argon atmosphere, the purified VISIOMER® MPEG 1005 MA W monomer(1.4680 g), LiTFSI(0.5320 g), 0.5 wt % DMPA(0.0073 g, based on the weight amount of VISIOMER® MPEG 1005 MA W monomer) were intensely stirred until forming a homogeneous viscous liquid, the molar ratio of EO/Li was set to be 18:1. The precursor solution was then casted onto a Teflon plate and exposed to the UV beam with 365 nm for 120 min at ambient temperature. The obtained electrolyte of Comparative Example 1 delivered ionic conductivity of 1.51×10⁻⁴ S cm⁻¹ at 30° C. and 7.87×10⁻⁴ S cm⁻¹ at 60° C.

The mechanical strength of the obtained electrolyte of Comparative Example 1 was tested by stress-strain measurements. As shown in FIG. 14, the tensile strength and Young's modulus of the obtained electrolyte of Comparative Example 1 are only 6.96 KPa and 6.99 KPa, respectively.

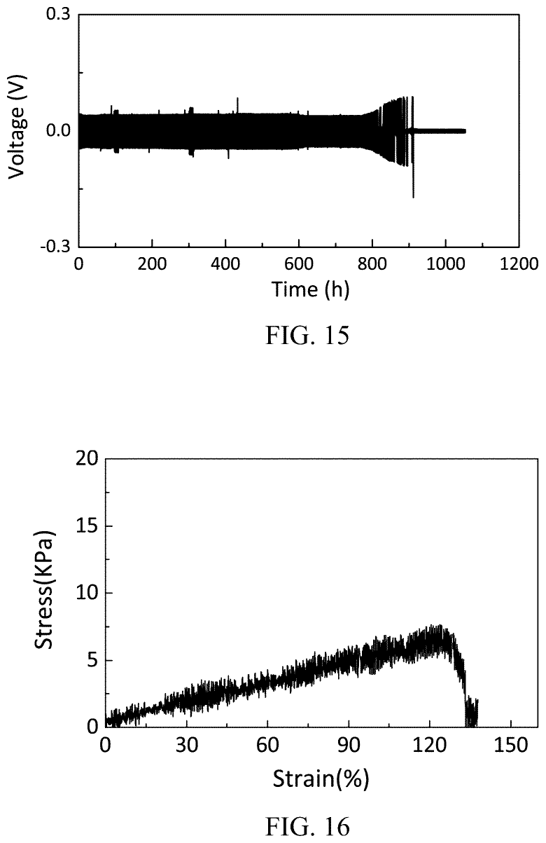

The interfacial stability between the obtained electrolyte in Comparative Example 1 and lithium metal was tested, as shown in FIG. 15, the Li/electrolyte/Li symmetric battery suffered from fluctuation after 800 hrs, and short circuit occurred after cycling for 900 hrs.

### Comparative Example 2

Under argon atmosphere, the purified VISIOMER® MPEG 1005 MA W monomer(1.4680 g), LiTFSI(0.5985 g), 0.5 wt % DMPA(0.0073 g, based on the weight amount of VISIOMER® MPEG 1005 MA W monomer) were intensely stirred until forming a homogeneous viscous liquid, the molar ratio of EO/Li was set to be 16:1. The precursor solution was then casted onto a Teflon plate and exposed to the UV beam with 365 nm for 120 min at ambient temperature. The obtained electrolyte of Comparative Example 2 delivered ionic conductivity of 1.36×10⁻⁴ S cm⁻¹ at 30° C. and 6.12×10⁻⁴ S cm⁻¹ at 60° C.

The mechanical strength of the obtained electrolyte of Comparative Example 2 was tested by stress-strain measurements. As shown in FIG. 16, the tensile strength and Young's modulus of the obtained electrolyte of Comparative Example 2 are only 6.19 KPa and 4.54 KPa, respectively.

### Comparative Example 3

All-solid-state lithium secondary batteries were assembled under argon atmosphere (O₂, H₂O<0.5 ppm), which consisted of a cathode, the obtained electrolyte of Comparative Example 1 and a lithium metal anode. The cathode slurry was obtained by blending LiFePO₄(0.4 g)/Super-P(0.05 g)/PEO(0.05 g)/LiClO₄(0.0067 g) at the weight ratio of 78.94%-9.87%:9.87%:1.32% in acetonitrile, and then the slurry was loaded directly onto aluminum foil by blade casting and dried under vacuum for 12 h at 100° C. to remove solvent.

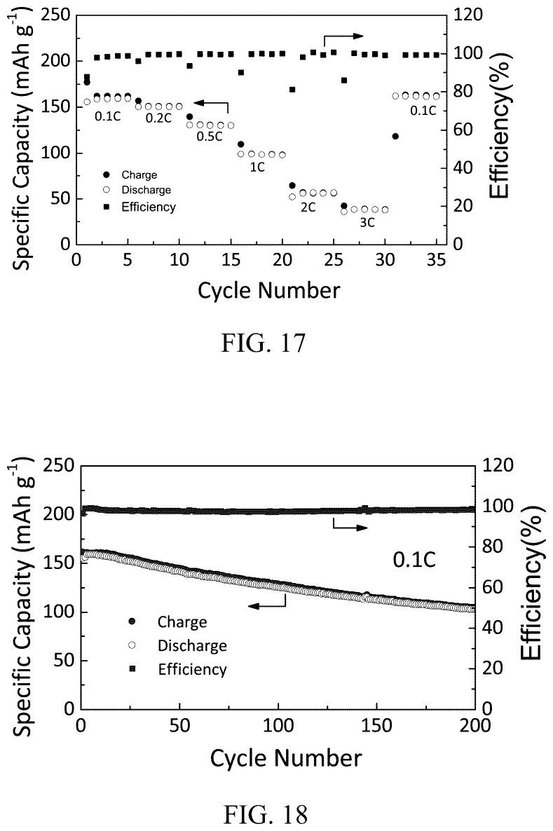

The rate performances of the all-solid-state lithium secondary battery at 60° C. are shown in FIG. 17, the maximum discharge specific capacities of the battery were 162.1 mAh g⁻¹, 150.7 mAh g⁻¹, 130.7 mAh g⁻¹, 99 mAh g⁻¹, 56.5 mAh g⁻¹, 38.6 mAh g⁻¹ at 0.1 C, 0.2 C, 0.5 C, 1 C, 2 C and 3 C, respectively, which were significantly inferior than those of the Example 8.

The cycling performances of the all-solid-state lithium secondary battery were evaluated at 0.1 C under 60° C. As shown in FIG. 18, the all-solid-state lithium secondary battery only showed discharge capacity of 103 mAh g⁻¹ with the capacity retention rate of 66.2% after 200 cycles.

The main performance test results were summarized in the following Table 1.

TABLE 1

| | | | | | Tensile | Young's |
|---|---|---|---|---|---|---|
| | Monomer | | σ@30° C. | σ@60° C. | strength | modulus |
| | ratio* | EO/Li⁺ | (S cm⁻¹) | (S cm⁻¹) | (KPa) | (KPa) |
| Example 1 | 1:0.804 | 18:1 | 1.22 × 10⁻⁶ | 7.58 × 10⁻⁶ | — | — |
| Example 2 | 1:1.608 | 18:1 | 2.02 × 10⁻⁵ | 9.82 × 10⁻⁵ | 22.57 | 1156.64 |
| Example 3 | 1:3.216 | 18:1 | — | 2.18 × 10⁻⁴ | — | — |
| Example 4 | 1:12.864 | 18:1 | 5.85 × 10⁻⁵ | 2.38 × 10⁻⁴ | — | — |
| Example 5 | 1:25.728 | 18:1 | 7.10 × 10⁻⁵ | 2.92 × 10⁻⁴ | 20.05 | 27.42 |
| Example 6 | 1:25.728 | 16:1 | 1 × 10⁻⁴ | 3.86 × 10⁻⁴ | 17.28 | 24.43 |
| Example 7 | 1:25.728 | 14:1 | 7.15 × 10⁻⁵ | 3.12 × 10⁻⁴ | — | — |
| Example 8 | 1:51.456 | 16:1 | 1.15 × 10⁻⁴ | 4.88 × 10⁻⁴ | 13.22 | 14.85 |
| Example 9 | 1:25.728 | 16:1 | 5.56 × 10⁻⁵ | 3.11 × 10⁻⁴ | — | — |
| (heat-cured) | | | | | | |
| Comparative | N/A | 18:1 | 1.51 × 10⁻⁴ | 7.87 × 10⁻⁴ | 6.96 | 6.99 |
| Example 1 | | | | | | |
| Comparative | N/A | 16:1 | 1.36 × 10⁻⁴ | 6.12 × 10⁻⁴ | 6.19 | 4.54 |
| Example 2 | | | | | | |

*represents weight ratio of siloxane monomer to EO-based monomer

As shown in Table 1, when the weight ratio of siloxane monomer to EQ-based monomer decreases, the ionic conductivity of the electrolyte of the invention increases but the mechanical strength of the electrolyte decreases, which is contrary to the teaching of US20030180624A1. When the molar ratio of EO/Li⁺ increased from 14:1 to 18:1, the ionic conductivity of the electrolyte surprisingly peaked at 16:1. The electrolytes of the invention have much better mechanical properties than those of comparative examples. Notably, in examples like Examples 6-8, the electrolytes have comparable ionic conductivity with comparative examples but much better mechanical properties.

As shown in Example 6, the Li/electrolyte/Li symmetric battery comprising the electrolyte of Example 6 can stably cycle for over 1800 hrs at current density of 0.1 mA cm⁻² at 60° C., which indicates the electrolyte has excellent interfacial stability with lithium metal and can efficiently suppress lithium dendrite due to its good mechanical property. In comparison, the Li/electrolyte/Li symmetric battery comprising the electrolyte of Comparative Example 1 suffered from fluctuation after 800 hrs, and short circuit occurs after cycling for 900 hrs, which indicates the interfacial stability between the obtained electrolyte in Comparative Example 1 and lithium metal was much worse than that of Example 6 and was poor.

As shown in Example 10, the all-solid-state lithium secondary battery comprising the electrolyte of Example 6 can still deliver a discharge capacity of 158.7 mAh g⁻¹ with the capacity retention rate of 97.6% after 200 cycles at 0.1 C under 60° C., which demonstrates excellent cycling performances of the all-solid-state lithium cell. In comparison, as shown in Comparative Example 3, the all-solid-state lithium secondary battery comprising the electrolyte of Comparative Example 1 only showed discharge capacity of 103 mAh g⁻¹ with the capacity retention rate of 66.2% after 200 cycles at 0.1 C under 60° C., which was much worse than that of Example 6.

As used herein, terms such as “comprise(s)” and the like as used herein are open terms meaning ‘including at least’ unless otherwise specifically noted.

All references, tests, standards, documents, publications, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A monomer composition, comprising, consisting essentially of, or consisting of:
A) an alkylene oxide-based monomer; and
B) a siloxane monomer;
wherein the siloxane monomer is a compound of formula (II),
M¹ₑM³_{f}D¹_{g}D³ₕ (II)
wherein
M¹=[R¹₃SiO_{1/2}],
M³=[R¹₂R³SiO_{1/2}],
D¹=[R¹₂SiO_{2/2}],
D³=[R¹R³SiO_{2/2}],
e=0,
f=0,
g=0 to 38,
h=4 to 15,
and a ratio of a sum (f+h) to a sum (g+h+2) is from 0.15 up to 1,
and the sum (g+h+2) is 5 to 40,
R¹ denotes identical or different aliphatic hydrocarbons having 1 to 10 carbon atoms or aromatic hydrocarbons having 6 to 12 carbon atoms,
R³ denotes identical or different hydrocarbons which have 1 to 5 identical or different ester, the hydrocarbon being linear, cyclic, branched and/or aromatic, and the ester being (meth-)acryloxy functions selected from the group consisting of ethylenically unsaturated, radically polymerizable esters, and ester groups which are not radically polymerizable;
wherein a number of radically polymerizable groups in the siloxane monomer is 3 or more.

2. The composition of claim 1, wherein in the siloxane monomer, the radically polymerizable groups are present in a numerical fraction of between 80-90%, based on a number of all ester functions of the compounds of the formula (II).

3. The composition of claim 1, wherein a weight ratio of the siloxane monomer to the alkylene oxide-based monomer is from 1:0.4 to 1:80.

4. The composition of claim 1, wherein the alkylene oxide-based monomer is an EO-based monomer or a PO-based monomer.

5. The composition of claim 1, wherein the alkylene oxide-based monomer is selected from the group consisting of EO based (meth-)acrylates and PO based (meth-)acrylates.

6. The composition of claim 5, wherein the alkylene oxide-based monomer is an EO-based monomer selected from the group consisting of polyethylene glycol (meth-)acrylates.

7. A copolymer electrolyte precursor composition for preparation of a solid polymer electrolyte, wherein the polymer electrolyte precursor composition comprises:
I) the monomer composition according to claim 1;
II) a lithium salt; and optionally
III) a free radical initiator for polymerization reaction.

8. The composition of claim 7, wherein the g molar ratio of AO/Li⁺ of alkylene oxide-based monomer and lithium salt is (12˜20):1.

9. A method, comprising:
a) mixing under protective atmosphere the copolymer electrolyte precursor composition of claim 7 comprising a free radical initiator until a homogeneous viscous liquid is formed; and
b) curing the liquid under UV radiation or heating.

10. The method of claim 9, wherein the chemical materials of the method comprise solvents in sum in an amount of from 0 to 10 wt. % based on a total weight of the chemical materials used in the method.

11. A solid copolymer electrolyte, wherein the electrolyte comprises:
a copolymer of the monomer composition according to claim 1, and
a lithium salt.

12. A solid-state lithium secondary battery, comprising:
a cathode, a solid copolymer electrolyte and an anode,
wherein the solid copolymer electrolyte is the solid copolymer electrolyte according to claim 11.

13. A method to prepare a solid-state lithium secondary battery,
comprising:
assembling a cathode, the solid copolymer electrolyte according to claim 11, and an anode, to form a solid-state lithium secondary battery.

14. An electrochemical device, comprising:
the solid polymer electrolyte according to claim 11.

15. A device, comprising:
the electrochemical device according to claim 14.

16. A method of improving electrolyte mechanical property, ionic conductivity, and/or cycling performance in a lithium secondary battery, comprising:
preparing a solid polymer electrolyte in a lithium secondary battery with the monomer composition according to claim 1.

17. A copolymer of the monomer composition according to claim 1.

18. The composition of claim 1, wherein a weight ratio of the siloxane monomer to the alkylene oxide-based monomer is from 1:12.8 to 1:52.

19. The composition of claim 5, wherein the alkylene oxide-based monomer is an EO-based monomer selected from the group consisting of methoxypolyethylene glycol methacrylate (MPEG MA), polyethylene glycol dimethacrylate (PEGDMA), polyethylene glycol methyl ether acrylate (PEGMEA), and polyethylene glycol diacrylate (PEGDA).
